(19) United States
(12) Patent Application Publication
(10) Pub. No.: US 2024/0132815 A1
(43) Pub. Date: Apr. 25, 2024

(54) METHODS FOR PRETREATING HOPS USED IN BREWING AND ALCOHOLIC BEVERAGES MADE FROM THE SAME

(71) Applicant: COORS BREWING COMPANY, Milwaukee, WI (US)

(72) Inventors: Andy D. PRESTON, Toronto (CA); Steven STRADIOTTO, Toronto (CA)

(21) Appl. No.: 18/548,200

(22) PCT Filed: Feb. 25, 2022
(86) PCT No.: PCT/US2022/017994

§ 371 Date: Aug. 27, 2023

Related U.S. Application Data
(60) Provisional application No. 63/156,208, filed on Mar. 3, 2021.

(51) Int. Cl. C12H 1/22; C12C 3/08; C12C 7/04; C12C 7/20

(52) U.S. Cl. CPC C12H 1/22; C12C 3/08; C12C 7/04; C12C 7/205

(57) ABSTRACT

Pretreating hops includes soaking hops in whiskey for a period of time until the hops absorb a portion of the whiskey and begin to swell. These pretreated hops are in the form of hop flowers, a hop extract, a concentrated hop resin or liquid, or combinations thereof. In any case, the pretreated hops take on the flavors and aromas of the whiskey. A beer product is described that uses these pretreated hops added during the boil stage of brewing the beer, during fermentation of the beer, and/or after fermentation of the beer. Adding the pretreated hops during the brewing process results in the flavors and aromas from the whiskey imparting to the beer. The process obviates the requirement for finishing the beer in whiskey barrels or adding whiskey to the beer product after manufacturing to obtain a complex flavor profile.

### CROSS REFERENCE TO RELATED APPLICATIONS

The present application claims the benefit of and priority, under 35 U.S.C. § 119(e), to U.S. Provisional Application Ser. No. 63/156,208, filed Mar. 3, 2021, entitled “Methods for Pretreating Hops Used in Brewing and Alcoholic Beverages Made from the Same,” the entire disclosure of which is hereby incorporated herein by reference, in its entirety, for all that it teaches and for all purposes.

### BACKGROUND

The present disclosure is generally directed to brewing beer, in particular, toward processes for pretreating hops used in brewing beer.

Finishing or aging brewed beer in wooden barrels, especially in spirits barrels, imparts flavors and aromas from both the barrel and the spirit to the brewed beer. While the practice of aging beer in barrels may be used in small batches or limited runs, scaling the production of barrel-aged beers is difficult and inefficient.

### DETAILED DESCRIPTION

It is with respect to the above issues and other problems that the embodiments presented herein were contemplated. It is an object the present disclosure to pretreat hops (e.g., using at least one of whiskey, rum, tequila, vodka, and/or other flavor spirit, etc.) before the pretreated hops are added in the beer brewing process. In some embodiments, pretreating the hops may comprise soaking hops in a select flavor spirit for a predetermined amount of time (e.g., two to three days, one to two weeks, etc.). The hops may be soaked until the flavor spirit is absorbed, at least in part, and the hops begin to swell or increase in size. These pretreated hops may be in the form of previously soaked hop flowers, a hop extract, a concentrated hop resin or liquid, and/or various combinations thereof. In any event, the pretreated hops take on the complex flavors and aromas of the flavor spirit. As described herein, these pretreated hops may be added during the boil stage of brewing, during fermentation of the beer, after fermentation of the beer, aging of the beer, post-filtration of the beer, finishing of the beer, and/or blending of the beer. In turn, the pretreated hops impart the complex flavors and aromas of, among other things, the selected flavor spirt and the hops to the beer.

The pretreatment of the hops may comprise combining a predetermined weight or amount of hops with a select flavor spirit in a container. In some embodiments, the container and/or the contents therein may be agitated or moved aiding in the absorption of the flavor spirit by the hops in the barrel. Additionally or alternatively, the acids, oils, flavor, aroma, and/or bittering compounds from the hops may be pulled into the flavor spirit (e.g., whiskey, rum, tequila, vodka, etc.) and a liquid hop extract may be made from this flavor spirit comprising the acids, oils, flavor, aroma, and/or bittering compounds from the hops. For example, a predetermined amount of hops may be added to a barrel with whiskey and the barrel may be rolled, or otherwise moved to ensure the hops have been adequately mixed in the whiskey. In one embodiment, the whiskey-soaked, or pretreated, hops may then be removed from the barrel and then used as the pretreated hops in brewing beer as described herein. In some embodiments, the whiskey-soaked hops may be removed from the barrel and then subjected to a hop extract process (e.g., a carbon dioxide, CO₂, process, solvent process, etc.) that extracts the various resins and oils from within the whiskey-soaked hops. In another embodiment, whiskey or some other flavor spirit may be added to an existing hop extract to form the pretreated hops as described herein. In yet another embodiment, the whiskey flavored by the acids, oils, flavor, aroma, and/or bittering compounds from the hops may be made into the liquid extract. A solvent process, as described in some embodiments herein, may correspond to an extract process that utilizes the flavor spirit (e.g., the whiskey, rum, tequila, vodka, etc.) as the solvent. In any event, the pretreated hops may be used in the form of a hop extract (e.g., a liquid, etc.) that is added during the brewing process of beer (e.g., at the boil stage of brewing, during fermentation of the beer, after fermentation of the beer, and/or the like) at aging of the beer, at post-filtration of the beer, at finishing of the beer, and/or at blending of the beer, etc. Benefits to using a liquid hop extract as opposed to hop flowers as the pretreated hops include, but are in no way limited to, providing reduced storage requirements (e.g., storing concentrated liquid takes up less space than storing the materials used to create the extract), ensuring freshness and/or shelf life, providing a better mix and/or interaction of ingredients during boiling of the wort (e.g., preventing absorption of wort by hop flowers, etc.), and providing increased fluid transfer reliability (e.g., reducing the number of solid ingredients used in the brewing process, etc.) to name a few.

Making the pretreated hops may comprise a hop extract production process that combines a flavor spirit (e.g., whiskey, rum, tequila, vodka, etc.) and hops (e.g., the flowers, or seed cones/strobiles, of the plant Humulus lupulus, etc.) together to form a liquid that retains hop bitterness and a complex flavor and aroma. In some embodiments, the flavor spirit described herein may correspond to any spirit, other than a neutral spirit (i.e., a rectified spirit, or a spirit with no added flavor, etc.), that has flavors imparted to it from the use of one or more grains (e.g., barley, corn, rye, wheat, etc.), plants (e.g., grapes, tubers, sugarcane, agave, potato, high-starch plant, high-sugar plant, etc.), and/or by aging/storing the spirit in wood (e.g., wooden barrels, charred wooden barrels, etc.). The hops may be selected from any varietal, or combination of varietals, of hops. Although the disclosure describes using whiskey as at least one of the flavor spirits, it should be appreciated that rum, tequila, and/or any other type of flavor spirit may be used to create the pretreated hops (e.g., liquid hop extract, etc.) as described herein. In one example, whiskey and hops may be stored in a container (e.g., a barrel, keg, vat, etc.) for a predetermined amount of time to form the pretreated hops in the form of a liquid hop extract. The predetermined amount of time may correspond to a number of hours, days, weeks, or more. In one example, the predetermined amount of time may correspond to 48 hours or more. The predetermined amount of time may correspond to a range of time, for instance, a period of time between, and including, 48 hours and 336 hours. In some examples this range of time may be between five days and two weeks. In some embodiments, the predetermined amount of time may be based on a change in size of the hops (e.g., swelling, etc.) due to soaking in the whiskey. During the predetermined amount of time, the whiskey and hops may be moved, stirred, mashed together, and/or otherwise agitated to ensure the whiskey is absorbed into all of the hops in the container and/or to ensure that the acids, oils, flavors, aromas, and/or bittering compounds from the hops are pulled into the whiskey. In one embodiment, whiskey barrels filled with the hops (and whiskey) may be rolled, or rotated, periodically ensuring the hops are coated in the whiskey and the whiskey is absorbed by the hops and/or the acids, oils, flavors, aromas, and/or bittering compounds from the hops are pulled into the whiskey. The time for soaking the whiskey and hops together in forming the liquid hop extract (i.e., the pretreated hops) may be within a range of 1-2 weeks or more.

In one embodiment, the approach described herein providing whiskey-aged hops and/or the liquid hop extract used as the pretreated hops during the brewing and/or post-brewing of a beer may produce a hearty lager that is rich with notes of toasted oak, vanilla, some coconut and caramel, and whiskey. By using whiskey to create the pretreated hops, the complex flavors and aromas of the whiskey are allowed to transfer to the beer during the brewing process and there is no requirement, or even need, to finish the beer in whiskey barrels, kegs, or the like. Stated another way, the pretreated hops impart the whiskey flavor to the beer while the beer is being brewed. As a result, the beer made with the pretreated hops may be produced in large batches or quantities while still maintaining the flavors and aromas expected of a product that is made by aging beer in a wooden spirit barrel.

The beer produced using pretreated hops may correspond to an amber lager featuring some form of the whiskey-aged hops (e.g., liquid hop extract, etc.). The whiskey-aged hops may impart complex flavors and aromas to the beer while being brewed, after brewing, or during finishing. Traditionally, beer was finished in whiskey barrels or whiskey was added to beer being finished to impart the complex flavors and aromas of whiskey to the beer. In contrast to adding an alcohol to a beer, adding the pretreated hops (e.g., liquid hop extract) to a beer during brewing, post-brewing, and/or aging, etc., allows the flavors of the select flavor spirit (e.g., whiskey, rum, tequila, vodka, etc.) as well as the acids, oils, flavors, aromas, and/or bittering compounds from the hops to be added to the beer in the form of a complex liquid hop extract. This pretreated hops approach allows beers with very complex flavor profiles to be produced efficiently in high quantities (e.g., large batches, etc.) without requiring finishing in wooden spirit barrels to impart flavor to the beer. As can be appreciated, the process described herein may allow high scalability of a complex spirit-flavored beer, that would otherwise be impossible using conventional techniques (e.g., storing the beer in wooden spirit barrels and aging, etc.).

The exemplary systems and methods of this disclosure have been described in relation to methods for pretreating hops used in brewing and alcoholic beverages made from the same. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method of forming pretreated hops, comprising: adding hops to a container; adding whiskey to the container; aging the hops with the whiskey in the container for a predetermined amount of time, wherein a portion of the whiskey is absorbed by the hops over the predetermined amount of time; and forming, after reaching the predetermined amount of time, the pretreated hops from the hops comprising the portion of the whiskey absorbed.

Aspects of the above method include wherein forming the pretreated hops further comprises: subjecting, after reaching the predetermined amount of time, the hops comprising the portion of the whiskey absorbed to at least one of carbon dioxide and a solvent; extracting acids, oils, flavor, aroma, and bittering compounds from the hops comprising the portion of the whiskey absorbed; and forming the pretreated hops as a liquid hop extract comprising the acids, oils, flavor, aroma, and bittering compounds extracted. Aspects of the above method include wherein the hops comprise at least one varietal of hops, and wherein the whiskey comprises a rye whiskey. Aspects of the above method include wherein, during the aging, the method further comprises: rotating, periodically during the predetermined amount of time, the container comprising the hops and whiskey. Aspects of the above method include wherein the container is a wooden whiskey barrel, and wherein the rotating comprises rolling the wooden whiskey barrel. Aspects of the above method further comprise: mashing a selected malted barley variety in a mash conversion vessel forming a mash; separating the mash forming a wort; transferring the wort to a kettle; and adding, during boiling of the wort, an amount of the pretreated hops imparting a flavor and aroma of the whiskey to the wort.

Embodiments include a method of manufacturing a beer, comprising: mashing a selected malted barley variety in a mash conversion vessel forming a mash; separating the mash forming a wort; transferring the wort to a kettle; and adding, during boiling of the wort, an amount of pretreated liquid hop extract to the kettle such that the amount of pretreated liquid hop extract mixes with the wort, wherein the amount of pretreated liquid hop extract comprises hops and whiskey.

Aspects of the above method include wherein the amount of pretreated liquid hop extract is formed by aging the hops with the whiskey in a container for a predetermined amount of time, wherein a portion of the whiskey is absorbed by the hops over the predetermined amount of time, subjecting the hops comprising the portion of the whiskey absorbed to at least one of carbon dioxide and a solvent, and extracting acids, oils, flavor, aroma, and bittering compounds from the hops comprising the portion of the whiskey absorbed.

Embodiments include an alcoholic beverage produced by a method comprising: mashing a selected malted barley variety in a mash conversion vessel forming a mash; separating the mash forming a wort; transferring the wort to a kettle; and adding, during boiling of the wort, an amount of pretreated liquid hop extract to the kettle such that the amount of pretreated liquid hop extract mixes with the wort, wherein the amount of pretreated liquid hop extract comprises hops and whiskey, and wherein the amount of pretreated liquid hop extract is formed by aging the hops with the whiskey in a container for a predetermined amount of time, wherein a portion of the whiskey is absorbed by the hops over the predetermined amount of time, subjecting the hops comprising the portion of the whiskey absorbed to at least one of carbon dioxide and a solvent, and extracting acids, oils, flavor, aroma, and bittering compounds from the hops comprising the portion of the whiskey absorbed.

Aspects of the above alcoholic beverage include wherein the hops comprise one or more varietal formed from at least one of a bittering hop and a wild hop, and wherein the whiskey comprises a rye whiskey.

Embodiments include an alcoholic beverage produced by a method comprising: mashing a selected malted barley variety in a mash conversion vessel forming a mash; separating the mash forming a wort; transferring the wort to a kettle; boiling the wort in the kettle; transferring, after boiling, the wort to a wort separation vessel separating a liquid from the wort; transferring the liquid to a fermentation tank; and adding an amount of pretreated liquid hop extract to the fermentation tank such that the amount of pretreated liquid hop extract mixes with the liquid in the fermentation tank, wherein the amount of pretreated liquid hop extract comprises hops and whiskey, and wherein the amount of pretreated liquid hop extract is formed by aging the hops with the whiskey in a container for a predetermined amount of time, wherein a portion of the whiskey is absorbed by the hops over the predetermined amount of time, subjecting the hops comprising the portion of the whiskey absorbed to at least one of carbon dioxide and a solvent, and extracting acids, oils, flavor, aroma, and bittering compounds from the hops comprising the portion of the whiskey absorbed.

Aspects of the above alcoholic beverage include wherein the amount of pretreated liquid hop extract is added to the fermentation tank prior to fermenting the liquid. Aspects of the above alcoholic beverage include wherein the amount of pretreated liquid hop extract is added to the fermentation tank after fermenting the liquid. Aspects of the above alcoholic beverage include wherein the amount of pretreated liquid hop extract is added to the fermentation tank during fermentation of the liquid. Aspects of the above alcoholic beverage include wherein the amount of pretreated liquid hop extract is added to the liquid at least one of while aging the liquid, after filtering the liquid, while finishing the liquid, and while blending the liquid.

Embodiments include a method of forming pretreated hops, comprising: adding hops to a container; adding a flavor spirit to the container; aging the hops with the flavor spirit in the container for a predetermined amount of time, wherein a portion of the flavor spirit is absorbed by the hops over the predetermined amount of time; and forming, after reaching the predetermined amount of time, the pretreated hops from the hops comprising the portion of the flavor spirit absorbed.

Aspects of the above method include wherein the flavor spirit is a spirit other than a neutral spirit without added flavors, and wherein acids, oils, flavors, aromas, and/or bittering compounds from the hops are pulled into the flavor spirit during the aging. Aspects of the above method include wherein the flavor spirit is at least one of a whiskey, a rum, a tequila, and a vodka. Aspects of the above method include wherein forming the pretreated hops further comprises: producing a liquid hop extract comprising the acids, oils, flavor, aroma, and/or bittering compounds from the hops and at least a portion of the flavor spirit. Aspects of the above method include.

Embodiments include alcoholic beverage produced by a method comprising: mashing a selected malted barley variety in a mash conversion vessel forming a mash; separating the mash forming a wort; transferring the wort to a kettle; boiling the wort in the kettle; transferring, after boiling, the wort to a wort separation vessel separating a liquid from the wort; transferring the liquid to a fermentation tank; and adding an amount of a pretreated liquid hop extract to the liquid, wherein the amount of pretreated liquid hop extract comprises a flavor spirit that includes acids, oils, flavor, aroma, and bittering compounds from hops in a liquid form.

Aspects of the above alcoholic beverage include wherein the flavor spirit is at least one of a whiskey, a rum, a tequila, and a vodka. Aspects of the above alcoholic beverage include wherein the pretreated liquid hop extract is formed by a manufacturing method comprising: adding hops to a container; adding the flavor spirit to the container; aging the hops with the flavor spirit in the container for a predetermined amount of time, wherein the acids, oils, flavor, aroma, and bittering compounds from the hops are pulled into the flavor spirit over the predetermined amount of time. Aspects of the above alcoholic beverage include wherein the amount of the pretreated liquid hop extract is added to the fermentation tank prior to fermenting the liquid. Aspects of the above alcoholic beverage include wherein the amount of the pretreated liquid hop extract is added to the fermentation tank after fermenting the liquid. Aspects of the above alcoholic beverage include wherein the amount of the pretreated liquid hop extract is added to the fermentation tank during fermentation of the liquid. Aspects of the above alcoholic beverage include wherein the amount of the pretreated liquid hop extract is added to the liquid at least one of while aging the liquid, after filtering the liquid, while finishing the liquid, and while blending the liquid.

Aspects of any of the above wherein the alcoholic beverage is a beer.

Aspects of any of the above wherein the predetermined amount of time is 48 hours or more. Aspects of any of the above wherein the predetermined amount of time corresponds to a range of time between 24 hours and 336 hours. Aspects of any of the above wherein the predetermined amount of time corresponds to a range of time between 48 hours and 336 hours. Aspects of any of the above wherein the predetermined amount of time corresponds to a range of time between five days and two weeks. Aspects of any of the above wherein the predetermined amount of time corresponds to a range of time between one week and two weeks.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation or technique.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

1-27. (canceled)

28. An alcoholic beverage produced by a method comprising:
mashing a selected malted barley variety in a mash conversion vessel forming a mash;
separating the mash forming a wort;
transferring the wort to a kettle;
boiling the wort in the kettle;
transferring, after boiling, the wort to a wort separation vessel separating a liquid from the wort;
transferring the liquid to a fermentation tank; and
adding an amount of a pretreated liquid hop extract to the liquid, wherein the amount of pretreated liquid hop extract comprises a flavor spirit that includes acids, oils, flavor, aroma, and bittering compounds from hops in a liquid form.

29. The alcoholic beverage of claim 28, wherein the flavor spirit is at least one of a whiskey, a rum, a tequila, and a vodka.

30. The alcoholic beverage of claim 29, wherein the pretreated liquid hop extract is formed by a manufacturing method comprising:
adding hops to a container;
adding the flavor spirit to the container; and
aging the hops with the flavor spirit in the container for a predetermined amount of time, wherein the acids, oils, flavor, aroma, and bittering compounds from the hops are pulled into the flavor spirit over the predetermined amount of time.

31. The alcoholic beverage of claim 30, wherein the amount of the pretreated liquid hop extract is added to the fermentation tank prior to fermenting the liquid.

32. The alcoholic beverage of claim 30, wherein the amount of the pretreated liquid hop extract is added to the fermentation tank after fermenting the liquid.

33. The alcoholic beverage of claim 30, wherein the amount of the pretreated liquid hop extract is added to the fermentation tank during fermentation of the liquid.

34. The alcoholic beverage of claim 30, wherein the amount of the pretreated liquid hop extract is added to the liquid at least one of while aging the liquid, after filtering the liquid, while finishing the liquid, and while blending the liquid.

35. The alcoholic beverage of claim 30, wherein the flavor spirit is a spirit other than a neutral spirit without added flavors.

36. A method of manufacturing a beer, comprising:
mashing a selected malted barley variety in a mash conversion vessel forming a mash;
separating the mash forming a wort;
transferring the wort to a kettle; and
adding, during boiling of the wort, an amount of pretreated liquid hop extract to the kettle such that the amount of pretreated liquid hop extract mixes with the wort, wherein the amount of pretreated liquid hop extract comprises hops and whiskey.

37. The method of claim 36, wherein the amount of pretreated liquid hop extract is formed by aging the hops with the whiskey in a container for a predetermined amount of time, wherein a portion of the whiskey is absorbed by the hops over the predetermined amount of time, subjecting the hops comprising the portion of the whiskey absorbed to at least one of carbon dioxide and a solvent, and extracting acids, oils, flavor, aroma, and bittering compounds from the hops comprising the portion of the whiskey absorbed.

38. The method of claim 37, wherein the hops comprise one or more hop varietals formed from at least one of a bittering hop and a wild hop, and wherein the whiskey comprises a rye whiskey.

39. The method of claim 38, wherein the amount of pretreated liquid hop extract is formed by rotating, periodically during the predetermined amount of time, the container comprising the hops and whiskey.

40. An alcoholic beverage produced by a method comprising:
mashing a selected malted barley variety in a mash conversion vessel forming a mash;
separating the mash forming a wort;
transferring the wort to a kettle;
boiling the wort in the kettle;
transferring, after boiling, the wort to a wort separation vessel separating a liquid from the wort;
transferring the liquid to a fermentation tank; and
adding an amount of pretreated liquid hop extract to the fermentation tank such that the amount of pretreated liquid hop extract mixes with the liquid in the fermentation tank, wherein the amount of pretreated liquid hop extract comprises hops and whiskey, and wherein the amount of pretreated liquid hop extract is formed by aging the hops with the whiskey in a container for a predetermined amount of time, wherein a portion of the whiskey is absorbed by the hops over the predetermined amount of time, subjecting the hops comprising the portion of the whiskey absorbed to at least one of carbon dioxide and a solvent, and extracting acids, oils, flavor, aroma, and bittering compounds from the hops comprising the portion of the whiskey absorbed.

41. The alcoholic beverage of claim 40, wherein the amount of pretreated liquid hop extract is added to the fermentation tank prior to fermenting the liquid.

42. The alcoholic beverage of claim 40, wherein the amount of pretreated liquid hop extract is added to the fermentation tank after fermenting the liquid.

43. The alcoholic beverage of claim 40, wherein the amount of pretreated liquid hop extract is added to the fermentation tank during fermentation of the liquid.

44. The alcoholic beverage of claim 40, wherein the amount of pretreated liquid hop extract is added to the liquid at least one of while aging the liquid, after filtering the liquid, while finishing the liquid, and while blending the liquid.

45. The alcoholic beverage of claim 40, wherein the alcoholic beverage is a beer.

46. The alcoholic beverage of claim 40, wherein the amount of pretreated liquid hop extract is formed by rotating, periodically during the predetermined amount of time, the container comprising the hops and whiskey.

47. The alcoholic beverage of claim 46, wherein the container is a wooden whiskey barrel, and wherein rotating the container comprises rolling the wooden whiskey barrel.
